(19) United States
(12) Patent Application Publication
(10) Pub. No.: US 2007/0039463 A1
(43) Pub. Date: Feb. 22, 2007

(54) Method and device for size-separating particles present in a fluid

(76) Inventors: Gert Desmet, Elewijt (BE); Jan Desmet, Herne (BE); Piotr Gzil, Kapellen (BE); David Clicq, St. Pieters-Leeuw (BE); Kris Pappaert, St. Pieters-Leeuw (BE); Johan Vanderhoeven, Evere (BE); Nico Vervoort, Mechelen (BE); Sarah Vankrunkelsven, Brussel (BE); Gino Baron, Tervuren (BE); Joost Van Den Cruyce, Opwijk (BE)

Correspondence Address: KNOBBE MARTENS OLSON & BEAR LLP, 2040 MAIN STREET, FOURTEENTH FLOOR, IRVINE, CA, 92614, US

(21) Appl. No.: 10/573,951

(22) PCT Filed: Sep. 30, 2004
(86) PCT No.: PCT/EP04/10926

§ 371 Date: Mar. 30, 2006

(30) Foreign Application Priority Data
Oct. 2, 2003 (EP) 03447244.9

(51) Int. Cl. B01D 53/22

(52) U.S. Cl. 95/45

(57) ABSTRACT

A method and device for separating particles in a fluid according to size is disclosed. The method includes the step of generating at least one recirculating flow by transporting a fluid containing the particles across a profiled surface carrying at least two adjacent regions of different depth which form a surface level step, where the fluid is transported by mechanically moving a flat first surface over the profiled surface. The adjacent regions of different depth are arranged such that the depth of the regions decreases in the net direction of a forward displacement of the first surface. A normal load is applied to at least one surface. The particles are allowed to separate by at least one recirculating flow generated by moving the first surface past the profiled surface.

### FIELD OF THE INVENTION

The invention is in the field of methods and devices for separating particles present in a fluid according to size.

### BACKGROUND TO THE INVENTION

The separation and size-characterisation of colloidal suspensions is a difficult problem, especially when high resolution is required or when the particles have a broad diameter range. Applications are found in the quality control of polymers, the emission control of burner or motor installations, the quality control of nano-bead production processes, etc. Large research efforts are also being applied in the fields of biology and clinical diagnostics to develop fast and robust methods for the separation and the sorting of cells and other biological components as viruses and proteins. The most popular technique used for the separation and characterization of particle mixtures is Field Flow Fractionation. This method however has the drawback of a limited separation resolution (Desai & Armstrong, 2003).

WO/9855858 discloses a method wherein shear-driven flows are used to transport the mobile phase liquid through chromatographic separation channels.

WO 03/008931 (Hvichia & Gasparini, 2003) discloses a method wherein a stepped channel is used to separate cells by retaining the oversized cells at the front of one of the steps. As during the operation the oversized cells are continuously pushed against the front of the step, this device is susceptible to blockage so causing damage to cells and fragile macromoleular assemblies, and requiring addition skill and time of the operator to achieve separation if at all.

There is a need for a method and device for the size-separation of particles in a fluid which overcomes the problems of the prior art and provides cost-effective, high resolution separation.

### SUMMARY OF INVENTION

The present invention relates to separation technique for the size separation of particles such as cells, proteins, DNA, large coiled DNA, glycoproteins, polysaccharides, macromolecules and polymer strands, micro-spheres, biological substances, organic compounds and other colloidal and super-micrometer particles. The invention uses a recirculating flow that originates from the movement of a flat surface past a second surface carrying at least two micro-machined regions of different depth and separated by a substantially sharp transition (surface level step). The inventors have found that this recirculating flow can be used as the basis of a method and device for separating particles from a fluid. The recirculating flow so generated pushes the oversized particles away from the step, whereas the undersized particles can pass beyond the step (FIG. 1). The basic invention can be exploited for both discontinuous (batch-mode or chromatography mode) and continuous types of separation. Inventors has further found that the presently disclosed size separation effect can be intensified by subjecting the moving wall to a high frequency series of successive forward/backward displacements and by the creation of micro-machined recirculation chambers in front of each step.

One embodiment of the present invention is a method for separating particles in a fluid according to size comprising the steps of

a) transporting a fluid containing said particles across a profiled surface carrying at least two adjacent regions of different depth which form a surface level step, wherein
the fluid is transported by mechanically moving a flat first surface across the profiled surface,
the adjacent regions of different depth are arranged such that the depth of the regions decreases in the net direction of a forward displacement of the first surface,
force is applied such that one surface is pushed towards the other surface, and

b) allowing the separation of said particles by means of the backflow of excluded particles, said backflow generated by moving said first surface past said profiled surface.

Another embodiment of the present invention is a method as described above wherein where the first surface overlaps with the profiled surface, the first surface lies flat and parallel to the portions of the profiled surface without regions of different depth.

Another embodiment of the present invention is a method as described above wherein where the first surface overlaps with the profiled surface, at least the region(s) of different depth overlap with the first surface.

Another embodiment of the present invention is a method as described above further comprising the step of collecting the particles from one or more adjacent regions of different depth.

Another embodiment of the present invention is a method as described above wherein the widths of two or more regions adjacent to the surface level step are different.

Another embodiment of the present invention is a method as described above wherein the regions of different depth are micro machined.

Another embodiment of the present invention is a method as described above wherein the first surface moves in an intermittent mode.

Another embodiment of the present invention is a method as described above wherein the first surface moves alternately forwards and backwards, each movement having a duration and a velocity selected such that the net displacement is in the forward direction.

Another embodiment of the present invention is a method as described above wherein one or more said regions of different depth regions each comprise an opening into a chamber.

Another embodiment of the present invention is a method as described above wherein said particles are non-covalently bound to said first surface before they reach said surface level step.

Another embodiment of the present invention is a method as described above wherein a selective force field is applied to selectively and temporarily direct at least one fraction of the particles towards a predetermined surface during a given period.

Another embodiment of the present invention is a method as described above wherein a side-outlet channel is provided near at least one side of said surface level step.

Another embodiment of the present invention is a method as described above wherein the particles are collected after the separation by applying a second flow parallel to said surface level step.

Another embodiment of the present invention is a method as described above wherein said fluid substances are continuously fed at a channel inlet and are continuously withdrawn from one or more outlet channels.

Another embodiment of the present invention is a method as described above further comprising, the step of collecting particles at said outlet channel(s).

Another embodiment of the present invention is a method as described above wherein the direction of said surface level step and the mean direction of the flow cross at an angle between 1° and 90°.

Another embodiment of the present invention is a method as described above wherein said fluid substances are fed at a limited section of the channel inlet only.

Another embodiment of the present invention is a device for separating particles in a fluid according to size comprising:

a profiled surface carrying at least two adjacent regions of different depth which form a surface level step,

a flat first surface that is capable of mechanically moving over the profiled surface, and

a means for mechanically moving said first surface over the profiled surface,

wherein the adjacent regions of different depth are arranged such that the depth of the surface level steps decreases in the net direction of the forward displacement of the first surface.

Another embodiment of the present invention is a device as described above wherein where the first surface overlaps with the profiled surface the first surface lies substantially flat and parallel to the portions of the profiled surface without regions of different depth.

Another embodiment of the present invention is a device as described above device wherein at least the region(s) of different depth of the profiled surface overlap with the first surface

Another embodiment of the present invention is a device as described above further comprising a means to apply a pressure to at least one surface.

Another embodiment of the present invention is a device as described above wherein the widths of two or more regions of different depth adjacent to the surface level step are different.

Another embodiment of the present invention is a device as described above wherein the regions of different depth are micro-machined.

Another embodiment of the present invention is a device as described above wherein the first surface is capable of moving in an intermittent mode.

Another embodiment of the present invention is a device as described above wherein the first surface is capable of moving alternately forwards and backwards, each movement having a duration and a velocity selected such that the net displacement is in the forward direction.

Another embodiment of the present invention is a device as described above wherein one or more said regions of different depth regions each comprise an opening into a chamber.

Another embodiment of the present invention is a device as described above wherein a side-outlet channel is provided near at least one side of said surface-level step.

Another embodiment of the present invention is a device as described above further comprising a means to apply a second flow parallel to said surface level step.

Another embodiment of the present invention is a device as described above further comprising an inlet channel and one or more outlet channels.

Another embodiment of the present invention is a device as described above further comprising means to continuously feed said fluid to the channel inlet, and withdraw a fluid from one or more outlet channels.

Another embodiment of the present invention is a device as described above wherein the direction of said surface level step and the mean direction of the forward displacement of the first surface cross at an angle between 1° and 90°.

Another embodiment of the present invention is a device as described above wherein the movement of the first surface past the profiled surface generates at least one recirculating flow.

Another embodiment of the present invention is a use of a device as described above for size-separating particles in a fluid.

### FIGURES

FIG. 1. View of the basic separation mechanism, showing how the induced recirculation flow prevents the oversized particles from entering the channel section after the step: injection phase (A) and separation phase (B).

FIG. 2. Comparison of the flow pattern in (A) shear-driven flow and in (B) pressure-driven flow conditions. Velocity profiles have been calculated with a commercial Computational Fluid Dynamics software package.

FIG. 3. Successive frames taken from a video recording of the movement of polystyrene beads transported by the movement of a flat surface past a micromachined step. The arrows denote the direction of the instantaneous velocity of the particles. The time interval between two successive frames is 50 ms.

FIG. 4. Three examples (top views, not to scale) of micro-machined surfaces which can be used to induce the size separation effect according to the present invention: a linearly operated channel with constant width (A), a linearly operated channel with varying channel width (B), and a rotationally operated channel (C).

FIG. 5. Possible schedules for the proposed intermittent (A) and the alternating transport modes (B).

FIG. 6. Schematic representation (longitudinal view, not to scale) of two examples of the micro-machined recirculation chambers which can be arranged in front of each step to increase the strength of the recirculating flows: chambers with straight side-walls (A) and chambers with diverging side-walls (B).

FIG. 7. Examples (top views, not to scale) of side-channel and slanted step arrangements for the conduction of continuous mode separations: linear channel with straight step (A), linear channel with single slanted step (B), linear channel with double symmetric slanted step (C), cylindrical channel with curved, radially oriented steps (D).

### DETAILED DESCRIPTION OF THE INVENTION

The present invention is based on the unexpected size separation effect resulting from the recirculating flow which originates from the parallel movement of a flat surface (M) across a second profiled surface (S) carrying at least two micro-machined regions (C1,C2, . . . ) of different depth and separated by a substantially sharp step (ST).

As disclosed herein, the sharp transition between two distinct recessed regions are referred to as a surface level step. By flat is meant essentially planar, but includes surfaces imperfections and surfaces that are grooved or regularly indented, but are still essentially planar.

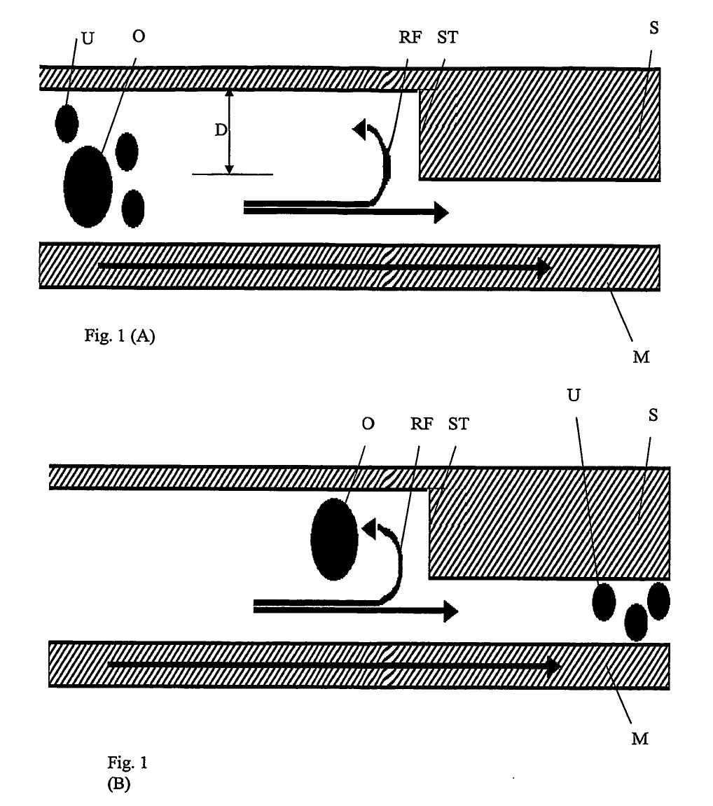

According to the method and device of the invention, a generated recirculating flow (RF) as shown in FIG. 1 pushes oversized particles (O) away from the thinner channel section after the step, whereas the undersized particles (U) can still pass the step.

The recirculating flow is a phenomenon observed in the present invention in which larger particles (e.g. FIG. 1(A), “O”), unable to pass through the channel created by the first flat surface and the machined regions of the profiled surface, flow backwards along the profiled surface in a direction opposite to that of the first flat surface (FIG. 1(B), “RF”). In other words, it is a backflow of the excluded particles. The recirculating flow is not a closed vortex since the larger particles “O” do not circulate around the same point. Instead, larger particles continue to move across the profiled surface in the opposite direction to the first flat surface until collected, for example, by a side channel.

As can be noted, the presently disclosed separation effect is size-selective: the larger the particles, the larger the repulsive force they experience and the smaller the probability they will pass beyond the step. The separation effect acts in such a way that the oversized particles are prevented from being forced against the step front and thereby blocking the channel. Thus, the recirculating flow phenomenon is essential for the operation of the present invention as it prevents oversized particles being squeezed at the stepwise channel reduction.

During the operation, a force (preferentially varying between 0.1 and 100 N/cm²) is applied such that one surface is pushed towards the other surface. According to one aspect of the invention, the direction or net direction of the force is perpendicular to the flat first surface. The force causes the flat first surface to push towards the second profiled surface or vice versa. The effect is to keep both surfaces in close contact. This force is needed to prevent the excess pressure which is created near the front of each step resulting in a normal shift of the stationary surface instead of resulting in a recirculating flow.

The force may be applied using any known method. For example, when the surfaces have a horizontal arrangement, and are supported from beneath, for example on a bench or flat bed, a weight or load may be applied from above having the result of one surface pressing toward another. Alternatively, in the horizontal arrangement, a force may originate from beneath the arrangement (in combination with an upper support), and the same effect of one surface pressing toward the other is achieved.

The force may originate from any part of either surface capable of receiving a force which results in one surface pushing toward the other.

It is within the scope of the invention that both surfaces are arranged horizontally, vertically or at any angle to the horizon. When the surfaces are arranged non-horizontally, force may be provided, for example, by means of suitable arranged clamp(s), hydraulic pistons, rack-and-pinion assemblies etc. applied to the exterior of one or both surfaces.

The invention is independent of gravity, therefore, as mentioned above, the arrangement may be held at any angle to the horizon. Furthermore, the flat surface may lie in a downward direction or upward direction while still maintaining contact with the second surface according to the invention.

The depth of a region as defined herein refers to the machining depth i.e. the minimum distance between a profiled surface and the plane of the profiled surface prior to the introduction of region of different depths. Such depth is indicated in FIG. 1(A) by reference sign “D”. According to one embodiment of the invention, the depth of the regions varies between 2 nanometer and 200 micrometer. According to another embodiment of the present invention, the difference in depth between adjacent steps is constant.

The number of regions of different depth may be at least 2, 3, 4, 5, 6, 7, 8, 9, 10, 11, 12, 13, 14, 15, 16, 17, 18, 19, or 20.

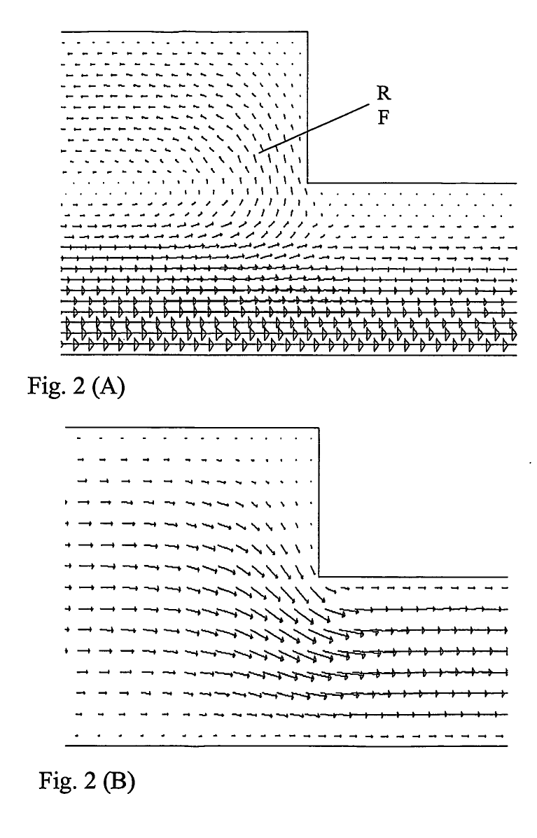

The fact that an important recirculating flow is generated when a moving wall is used to drag a thin layer of fluid past a sudden change in the channel depth has been demonstrated by performing hydrodynamic simulations with a commercial Computational Fluid Dynamics software package (FIG. 2a). When a conventional pressure-driven flow is applied, the recirculating flow pattern is completely absent (FIG. 2b). In this case, the hydrodynamic forces acting upon the particles of the sample all point in the direction of the step entrance. This of course constitutes a major source of pore blockage and is a clear problem with devices and methods of the art that are pressure driven.

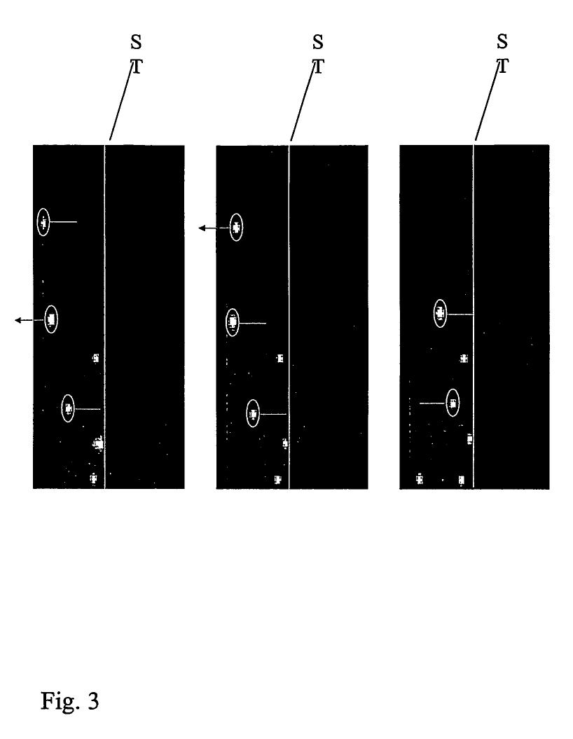

FIG. 3 shows a video image sequence of oversized particles continuously moving forward, backward and sideways in the vicinity of a step. This behaviour can only be explained through the presence of a recirculating flow. With a pressure-driven flow, the particles would constantly be pushed against the step front, and they would not make any free excursion away from the step. It is obvious that the type of size separation obtained in a pressure-driven flow is highly susceptible to step blockage, whereas the type of size separation obtained through a secondary flow caused by recirculation still allows the oversized particles to regularly leave the step front, thereby giving the undersized particles the opportunity to pass the step.

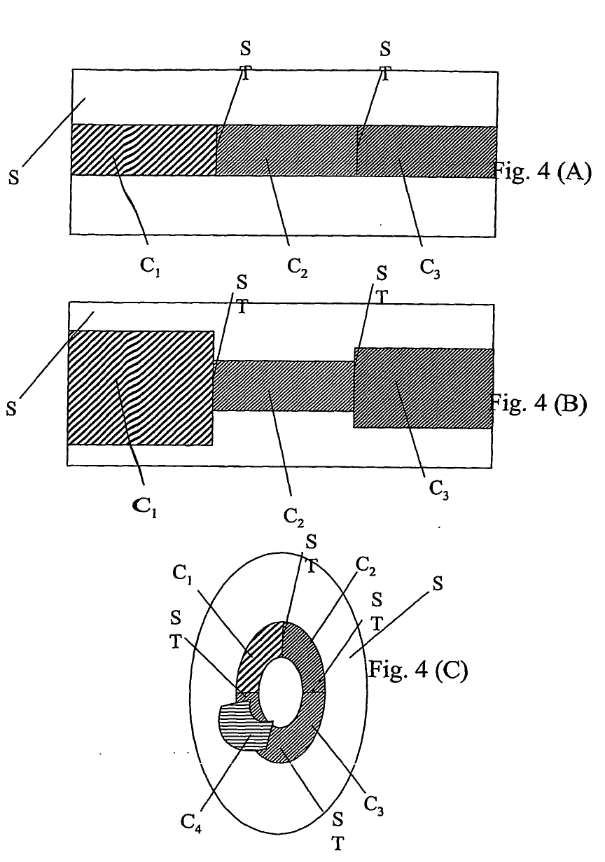

FIG. 4 shows two examples of possible arrangements of the stationary surface carrying the micro-machined regions of different depth (the zones are arranged such that their depth decreases in the net direction of forward displacement). One preferred method is obtained when the successive surface recession steps form a linear zone (FIG. 4a), another preferred method is obtained when the successive surface recession steps form a circular zone (FIG. 4b). To control the strength of the recirculating flow, the width of the successive recessed channel regions can be varied (FIG. 4c).

It should be noted that the plan-view of the steps can have all possible shapes and should not be limited to the straight line shape shown in FIG. 4.

It is an aspect of the invention that where the first surface overlaps with the separating surface, the first surface lies parallel to the portions of the separating surface without regions of different depth i.e. it is parallel to the plane of the separating surface as it appears prior to the introduction regions of different depth.

It is another aspect of the invention is that the first surface does not lie parallel to the portions of the separating surface without regions of different depth, but lies at an angle thereto. The angle may be such that the separation achieved is the same or better than the parallel arrangement.

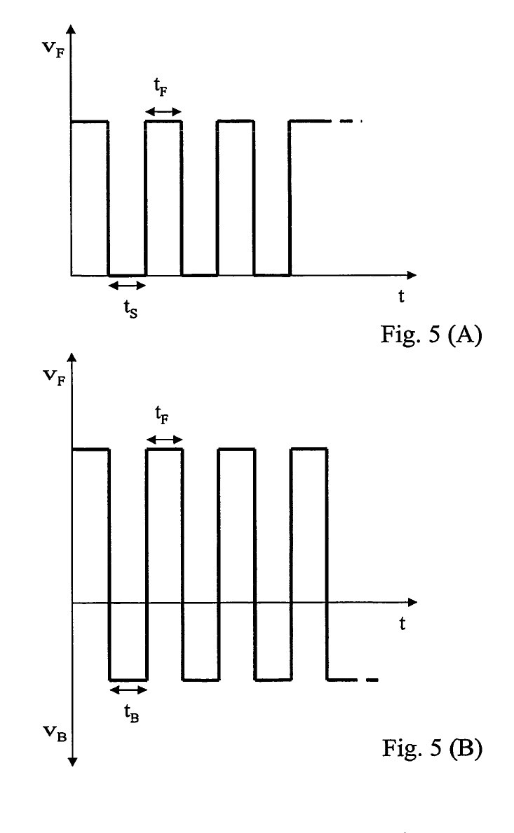

To increase the strength of the recirculating flow shown in FIG. 1, it is within the scope of the invention that the moving surface is subjected to a high frequency series of successive move stop sequences or to a series of forward and backward displacements. FIG. 5 shows possible examples for the timing schedule of the forward displacements (velocity v_{F}, duration t_{F}), the backward displacements (velocity v_{B}, duration t_{B}) and the stop periods (duration t_{S}).

In one embodiment of the invention, the displacement velocities are between 10 cm/s and 0.01 μm/s, 5 cm/s and 0.01 μm/s, 1 cm/s and 0.01 μm/s, 10 cm/s and 0.1 μm/s, or 10 cm/s and 0.5 μm/s, or preferably between 1 μm/s and 1 mm/s, without excluding any other values.

The duration of the stop periods should preferably be of the order of the time needed by the particles to travel one equivalent diameter distance by means of pure Brownian motion. In one embodiment of the invention, the duration of the stop periods should be between 10 μs to 50 ms, 100 μs to 50 ms, 1 ms to 50 ms, or 1 μs to 10 ms, or preferably be between 1 μs to 50 ms, without excluding any other values.

To minimize the risk for step blockage, it is an aspect of the invention that the displacement effectuated during each individual displacement phase is preferably smaller than the diameter of the individual particles and should hence preferably lie between 0.01 μm and 100 μm, without excluding any other values.

To allow the undersized particles to pass the successive surface level steps, it is an aspect of the invention that the sum of all forward displacement distances is larger than the sum of all backward displacement distances. The above mentioned displacement frequencies, displacement velocities and displacement distances are within the capabilities of the current state of the art means to drive the movements of the first surface, such as for example, a stepping-motor. It should also be noted that, although the timing schedule shown in FIG. 5 suggests the use of rectangular and repetitive displacement velocity profiles, the present invention also relates to the use of sloped (or sinusoidal or any other possible gradual variation) and non-repetitive displacement velocity profiles.

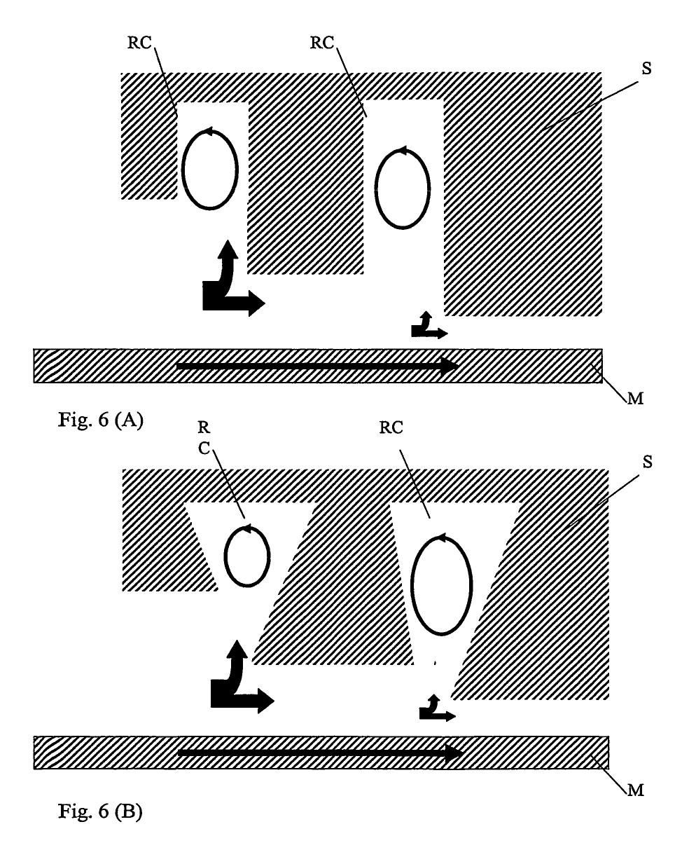

The inventors have found that another means to increase the strength of the recirculating flow pattern depicted in FIG. 1, is the arrangement of micro-machined recirculation chambers in front of each step (FIG. 6) i.e. openings in the regions of different depths into chambers. According to one aspect of the invention, these recirculation chambers have a depth between 100 nm and 50 μm and should preferentially be between 1 μm and 100 μm long without excluding any other values. The recirculation chambers have an additional advantage in that they considerably increase the retention capacity of each step.

To prevent the undersized particles from entering the recirculation chambers (RC), it is an aspect of the invention that all particles are forced against the moving wall before they reach the first step. By transporting the particles while being attached to the moving wall, they can not enter the recirculation chambers. When the force with which the particles are forced against the moving wall is not too strong, the attached particles will be detached from the moving wall as soon as they reach the step for which they are oversized. Means to generate this force can for example be, but not limited to: non-covalent bonding, the application of a hydrophobic or a ion-exchange coating to the moving wall or any other means to achieve physio-adsorption or chemo-adsorption, or the application of a tunable, radially directed force field (electrical force, magnetic force, dielectrophoretic force, thermophoretic force, . . . ).

When the direction of the force is reversed, and when this force is selective for a given property of the cells or the particles to be separated, particles of a given type can be temporarily withdrawn from the separation process by adsorbing them to the stationary surface wall. This can be exploited to separate particles of the same size but with a different other property such as charge, magnetic susceptibility or dielectric polarisability. The use of di-electrophoretic forces to separate particles with the same size but with a different density or dielectric polarization factor is for example described in (Wang et al., 2000).

After the separation, the retained particles can, for example, be detected by making direct fluorescence or absorbance measurements through an optical window. The particles can, however, also be collected by applying a flow parallel to the step to transport therm in the direction of side channels arranged on at least one side of each step, where they can be collected for subsequent analysis or processing. This is another aspect of the invention.

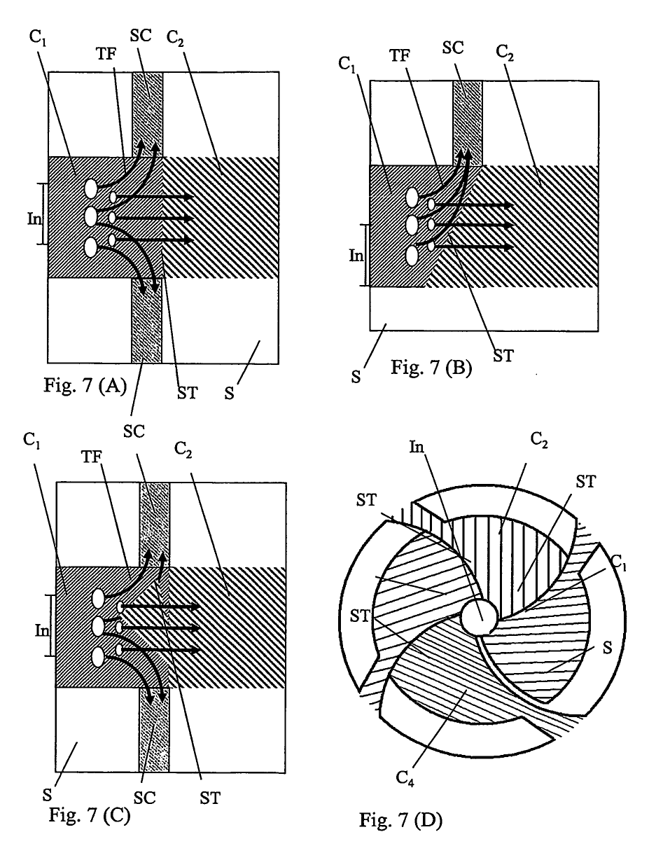

Since the oversized particles are not pushed against the step front but can still move freely (cf. FIG. 3), the presently disclosed size separation effect can also be exploited to perform continuous separations. This continuous mode can be obtained by arranging side-channels near each step and feeding the sample in a continuous mode. As the presence of the side-channels gives rise to a tertiary flow (TF) in the direction of the side-channels (SC), the oversized particles will experience a net force in the direction of the side-channels (FIG. 7a).

It is an aspect of the invention that a side channel is formed from a groove or passage in the second surface which connects a region of different depth in the vicinity of the surface level step with an outlet for the sized particle.

To give the oversized particles an additional impulse in the direction of the side-channels, it is another aspect of the invention that the steps can be machined such that they are curved or form a given angle (different from the 90° angle shown in FIG. 7a) with the direction in which the moving surface is displaced (FIG. 7b). It is an aspect of the invention that the angle range may be between 1 and 90 deg, 10 to 90 deg, 20 to 90 deg, 30 to 90 deg, 40 to 90 deg, 50 to 90 deg, 60 to 90 deg, 70 to 90 deg or 80 to 90 deg. To double the outlet channel capacity, it is an aspect of the invention that a symmetrically slanted profile as shown in FIG. 7c can be used. When operating the moving surface in a rotational mode, it is an aspect of the invention that the steps are provided in a curved, radially oriented way (FIG. 7d). For all continuously operating devices according to the present invention, the sample should preferably only be applied at a limited part (In) of the channel inlet plane. This prevents the undersized particles from being entrained by the tertiary flow.

In a preferred embodiment, the depth, length and width of the channels are different from one another to control the strength of the recirculating flows at the different steps.

The inventors have found that the shear-driven flow induces a rapid rotation of the individual particles. For the applications in the field of biology and biochemistry, this is a highly advantageous feature, as it reduces the likelihood of cell or protein adsorption to the channel walls.

It is another advantage of the present invention that the method and the device, in an embodiment of the invention, require only two completely detached parts (surfaces), only held together by applying force such that one surface is pushed towards the other surface during the operation. After the operation, the force can easily be removed and the two flat surfaces can simply be taken apart. This of course greatly facilitates the cleaning procedure over pressure or electrically-driven flow systems where the operation requires a hermetically sealed channel (apart of course from the in- and outlet ports).

### REFERENCES

Hvichia, G. and Gasparini, P., microstructure for particle and cell separation, identification, sorting and manipulation, WO/03/009831

Desmet G. and Baron, G. V. (1998), Method for separating a fluid substance and a device therefor, WO/9855858

Armstrong, D. W. & Desai, M. J. Separation, identification and characterization of micro-organisms by capillary electrophoresis. Microbiology and molecular biology reviews, 2003, 67, 38-51

Wang, X. B.; Yang, J.; Huang, Y.; Vykoukal, J.; Becker, F. F.; Gascoyne, C. (2000). Cell Separation by Dielectrophoretic Field-flow-fractionation Anal Chem. 72, 832-839.

1. A method for separating particles in a fluid according to size comprising the steps of
a) transporting the fluid comprising said particles across a profiled surface comprising at least two adjacent regions of different depth which form a surface level step, wherein
the fluid is transported by mechanically moving a flat first surface across the profiled surface,
the adjacent regions of different depth are arranged such that the depth of the regions decreases in the net direction of a forward displacement of the first surface,
the depth of the regions is between 2 and 200 micrometers,
force is applied such that one surface is pushed towards the other surface, and
b) separating said particles by means of the backflow of excluded particles, said backflow generated by moving said first surface past said profiled surface.

2. The method according to claim 1, wherein where the first surface overlaps with the profiled surface, the first surface lies flat and parallel to portions of the profiled surface without regions of different depth.

3. The method according to claim 1, wherein where the first surface overlaps with the profiled surface, the region(s) of different depth overlap with the first surface.

4. The method according to claim 1, further comprising the step of collecting the particles from one or more adjacent regions of different depth.

5. The method according to claim 1, wherein the widths of two or more regions adjacent to the surface level step are different.

6. The method according to claim 1, wherein the regions of different depth are micro machined.

7. The method according to claim 1, wherein the first surface moves in an intermittent mode.

8. The method according to claim 1, wherein the first surface moves alternately forwards and backwards, each movement having a duration and a velocity selected such that the net displacement is in the forward direction.

9. The method according to claim 1, wherein each of one or more of said regions of different depth comprise an opening into a chamber.

10. The method according to claim 1, wherein said particles are non-covalently bound to said first surface before they reach said surface level step.

11. The method according to claim 1, wherein a selective force field is applied to selectively and temporarily direct at least one fraction of the particles towards a predetermined surface during a given period.

12. The method according to claim 1, wherein a side-outlet channel is provided near at least one side of said surface level step.

13. The method according to claim 1, wherein the particles are collected after the separation by applying a second flow parallel to said surface level step.

14. The method according to claim 1, wherein said fluid substances are continuously fed at a channel inlet and are continuously withdrawn from one or more outlet channels.

15. The method according to claim 12, further comprising, the step of collecting particles at said outlet channel(s).

16. The method according to claim 1, wherein the direction of said surface level step and a mean direction of the flow cross at an angle between 1° and 90°.

17. The method according to claim 14, wherein said fluid substances are fed at a limited section of the channel inlet only.

18. A device for separating particles in a fluid according to size comprising:
a profiled surface comprising at least two adjacent regions of different depth which form a surface level step, in which the depth of the regions is between 2 and 200 micrometers,
a flat first surface that is capable of mechanically moving across the profiled surface, and
a means for mechanically moving said first surface over the profiled surface,
wherein the adjacent regions of different depth are arranged such that the depth of the surface level steps decreases in the net direction of the forward displacement of the first surface.

19. The device according to claim 18 wherein where the first surface overlaps with the profiled surface, the first surface lies substantially flat and parallel to portions of the profiled surface without regions of different depth.

20. The device according to claim 18, wherein at least the region(s) of different depth of the profiled surface overlap with the first surface.

21. The device according to claim 18, further comprising a means to apply a pressure to at least one surface.

22. The device according to claim 18, wherein the widths of two or more regions of different depth adjacent to the surface level step are different.

23. The device according to claim 18, wherein the regions of different depth are micro-machined.

24. The device according to claim 18, wherein the first surface is capable of moving in an intermittent mode.

25. The device according to claim 18, wherein the first surface is capable of moving alternately forwards and backwards, each movement having a duration and a velocity selected such that the net displacement is in the forward direction.

26. The device according to claim 18, wherein each of one or more of said regions of different depth comprise an opening into a chamber.

27. The device according to claim 18, wherein a side-outlet channel is provided near at least one side of said surface level step.

28. The device according to claim 18, further comprising a means to apply a second flow parallel to said surface level step.

29. The device according to claim 18, further comprising an inlet channel and one or more outlet channels.

30. The device according to claim 29, further comprising means to continuously feed said fluid to the channel inlet, and withdraw a fluid from one or more outlet channels.

31. The device according to claim 19, wherein the direction of said surface level step and a mean direction of the forward displacement of the first surface cross at an angle between 1° and 90°.

32. The device according to claim 19, wherein the movement of the first surface past the profiled surface generates at least one recirculating flow.

33. A method for size-separating particles in a fluid comprising:
transporting the fluid comprising said particles across the profiled surface of the device of claim 19; and
separating said particles by means of a backflow generated by moving said flat first surface past said profiled surface.
